(19) United States
(12) Patent Application Publication
(10) Pub. No.: US 2025/0370249 A1
(43) Pub. Date: Dec. 4, 2025

(54) APPARATUSES AND SYSTEMS FOR SHIELDING AN OPTICAL SENSOR, SELF-CLEANING OPTICAL SENSOR ASSEMBLY, AND METHODS OF USING THE SAME

(71) Applicant: GEORGIA-PACIFIC GYPSUM LLC, Atlanta, GA (US)

(72) Inventor: Peter Lloyd Davis, JR., Discovery Bay, CA (US)

(21) Appl. No.: 18/874,097

(22) PCT Filed: Jul. 27, 2023
(86) PCT No.: PCT/IB2023/057624

§ 371 Date: Dec. 12, 2024

Related U.S. Application Data
(60) Provisional application No. 63/394,749, filed on Aug. 3, 2022.

(51) Int. Cl. G02B 27/00; B08B 5/02; B08B 17/02

(52) U.S. Cl. CPC G02B 27/0006; B08B 5/02; B08B 17/02

(57) ABSTRACT

Methods, apparatuses, assemblies, and/or the like are provided. An example apparatus may include a housing assembly including a first component and a second component configured for selective attachment to the first component, the first component having a first annular portion and the second component having a second annular portion opposite the first annular portion, the first and second annular portions collectively defining a central opening of the housing assembly, the central opening defining a longitudinal axis of the housing assembly. An example apparatus may also include a fan assembly, which may include a fan having an airflow opening and a fan housing, wherein: the second component has a curved portion extending from the second annular portion and along the longitudinal axis, the curved portion having an opening formed therethrough, the opening defining at least one airflow passage extending from an exterior surface of the curved portion to an interior surface.

### CROSS-REFERENCE TO RELATED APPLICATIONS

This application claims the benefit of and priority to U.S. Provisional Patent Application No. 63/394,749, filed Aug. 3, 2022, the entire contents of which are hereby incorporated herein by reference.

### TECHNICAL FIELD

The present disclosure relates generally to materials manufacturing, and more particularly to cleaning and maintenance of photo eye sensors used in gypsum manufacturing operations.

### BACKGROUND

During gypsum manufacturing (and material manufacturing broadly), photo eye sensors (such as the Banner SM30 series with an emitter/receiver setup) are relied upon for board tracking during the manufacturing process. However, the effectiveness of these sensors may be impacted by debris that is created during product disengagement. Product disengagement occurs primarily in manufacturing process areas where board is cut, accelerated, decelerated, booked, and transferred. Disengagement is generally seen as unavoidable during the manufacturing process.

Many gypsum manufacturing plants (and many material manufacturing plants broadly) face technical challenges and difficulties caused by debris falling onto and thereby occluding the photo eye sensors. For example, disengagement from gypsum products may fall onto the photo eye sensor lens and block the emitter from seeing the receiver, causing constant photo eye flicker alarms and forcing the manufacturing process to stop when the controller no longer knows the location of the product on the line. Further, particularly for mobile sensors, static charge may build up on the lens and/or other components of the photo eye sensors, which may attract dust, particulate matter, and other materials that may occlude the photo eye sensors and impact their performance.

A mitigating solution is to have plant operators manually clean the debris from the photo eye sensors (e.g., by using cotton swabs). This may occur, for example, during product change overs. Applicants have identified that this manual cleaning process may be time and labor intensive and may negatively affect gypsum manufacturing throughout an entire plant. For example, some gypsum manufacturing operations may make use of dozens of photo eye sensors, compounding the time and labor requirements for manual cleaning.

Through applied effort, ingenuity, and innovation, Applicant has solved problems relating to debris impairing the effectiveness of photo eye sensors used in gypsum manufacturing by developing solutions embodied in the present disclosure, which are described in detail below.

### BRIEF SUMMARY

In general, various embodiments of the present disclosure provide methods, apparatuses, systems, computing devices, computing entities, and/or the like.

According to some embodiments, an apparatus for shielding an adjacent lens is provided. In some embodiments the apparatus includes a housing assembly. In further embodiments, the housing assembly may include a first component and a second component. In still further embodiments, the second component may be configured for selective attachment to the first component. In further embodiments, the first component may have a first annular portion and the second component may have a second annular portion opposite the first annular portion. In still further embodiments, the first and second annular portions may define a central opening of the housing assembly. In some embodiments, the central opening may define a longitudinal axis of the housing assembly.

In additional embodiments, the apparatus may include a fan assembly. In further embodiments, the fan assembly may include a fan having an airflow opening and a fan housing. In some embodiments, the second component may have a curved portion that extends from the second annular portion and along the longitudinal axis. In further embodiments, the curved portion may have an opening formed therethrough. In still further embodiments, the opening may define at least one airflow passage that extends from an exterior surface of the curved portion to an interior surface of the curved portion. In some embodiments, the fan may be mounted adjacent the exterior surface of the curved portion, such that airflow from the airflow opening of the fan is directed through the at least one airflow passage of the curved portion.

According to some embodiments, the interior surface of the curved portion may have a parabolic profile, while in others the parabolic profile of the curved portion may match a parabolic viewing angle of the adjacent lens and/or the at least one airflow passage may contain two distinct sub-passages.

According to some embodiments, the two distinct sub-passages may have a decreasing area cross-section extending from the exterior surface to the interior surface of the curved portion; the decreasing area cross-section area may decrease from an area of approximately 142 square millimeters to an area of approximately 50 square millimeters; and/or the at least one airflow passage may have a decreasing area cross-section extending from the exterior surface to the interior surface of the curved portion.

According to some embodiments, a longitudinal axis of the at least one airflow passage may be offset at an acute angle relative to the longitudinal axis of the housing assembly. According to some embodiments, the acute angle may be in a range of 55 to 72 degrees. According to some embodiments, the acute angle may be approximately 62 degrees. According to other embodiments, a longitudinal axis of the at least one airflow passage may be offset at an acute angle relative to the central opening plane. According to some embodiments, the acute angle may be in a range of 18 to 35 degrees. According to some embodiments, the acute angle may be 28 degrees.

According to some embodiments, the fan assembly may be offset at an acute angle relative to the longitudinal axis of the housing assembly. According to some embodiments, the acute angle may be in a range of 55 to 72 degrees. In these and other embodiments, the fan assembly may be offset at an acute angle relative to a plane perpendicular to the longitudinal axis of the housing assembly. In still other embodiments, the acute angle may be in a range of 18 to 35 degrees.

According to some embodiments, the fan assembly may also include at least one of a base portion and a shield portion, the base and shield portions being selectively attachable to opposing sides of the fan housing; and/or the base portion may have an open recess sized to receive and retain a fan filter therein. In these and other embodiments, the first and second annular portions may contain threads configured to retain the first and second annular portions relative to a portion of the shielded lens.

According to some embodiments, a shielded lens assembly is provided. In some embodiments, the shielded lens assembly may include a sensor. In further embodiments, the sensor may include a shaft having a lens mounted at one end thereof. In some embodiments, the lens may define a plane aligned with a surface of the lens and having a defined view profile. In some embodiments, a housing assembly may include a first component and a second component configured for selective attachment to the first component. In some embodiments, the first component may have a first annular portion and the second component having a second annular portion opposite the first annular portion. In some embodiments, the first and second annular portions may collectively define a central opening of the housing assembly sized to receive and secure a portion of the shaft. In some embodiments, the assembly may include a fan assembly comprising a fan having an airflow opening and a fan housing. In some embodiments, the second component may have a curved portion extending from the second annular portion and away from the lens. In some embodiments, the curved portion may have an opening formed therethrough, the opening defining at least one airflow passage extending from an exterior surface of the curved portion to an interior surface of the curved portion. In some embodiments, the fan may be mounted adjacent the exterior surface of the curved portion, such that airflow from the airflow opening of the fan is directed through the at least one airflow passage of the curved portion. In some embodiments, the assembly may include one or more ionizer units configured to ionize air passing through the at least one airflow passage.

According to some embodiments, a method for protecting a lens from debris is provided. In some embodiments, the method may include operatively connecting an apparatus for shielding an optical sensor assembly to a sensor assembly. In some embodiments, the optical sensor assembly may include a shaft having a lens mounted at one end thereof, the lens defining a plane aligned with a surface of the lens and having a defined view profile. In some embodiments, the apparatus include a housing assembly. In some embodiments, the housing assembly includes a first component and a second component configured for selective attachment to the first component. the first component having a first annular portion and the second component having a second annular portion opposite the first annular portion, the first and second annular portions collectively defining a central opening of the housing assembly sized to receive and secure a portion of the shaft, the central opening defining a longitudinal axis of the housing assembly. In some embodiments, the fan assembly may include a fan having an airflow opening and a fan housing. In some embodiments, the second component may have a curved portion extending from the second annular portion and away from the lens. In some embodiments, the curved portion may have an opening formed therethrough. In some embodiments, the opening may have at least one airflow passage extending from an exterior surface of the curved portion to an interior surface of the curved portion. In further embodiments, the fan may be mounted adjacent the exterior surface of the curved portion, such that airflow from the airflow opening of the fan is directed through the at least one airflow passage of the curved portion. In some embodiments, the method may include a step of orienting the fan assembly of the apparatus for shielding an optical sensor assembly at an angle that is offset from the central axis defined by the shaft of the sensor assembly such that debris does not collect on the lens. In further embodiments, the method may also include aligning the housing assembly of the apparatus for shielding an optical sensor assembly such that the first and second components of the housing assembly are aligned with the view profile of the lens. In still further embodiments, the method may include engaging the fan to blow debris such that debris does not collect on the lens.

The above summary is provided merely for purposes of summarizing some example various embodiments to provide a basic understanding of some embodiments of the disclosure. Accordingly, it will be appreciated that the above-described various embodiments are merely examples. It will be appreciated that the scope of the disclosure encompasses many potential various embodiments in addition to those here summarized, some of which will be further described below.

### BRIEF DESCRIPTION OF THE SEVERAL VIEWS OF THE DRAWINGS

Having thus described the disclosure in general terms, reference will now be made to the accompanying drawings, which are not necessarily drawn to scale, and wherein:

FIG. 1 is an example isometric view of an example system for shielding an optical sensor assembly that can be used in accordance with various embodiments of the present disclosure;

FIG. 2 is an example exploded view of an example system for shielding an optical sensor assembly and its various components that can be used in accordance with various embodiments of the present disclosure;

FIG. 3 is an example perspective view of an example system for shielding an optical sensor assembly in accordance with various embodiments of the present disclosure;

FIGS. 4A and 4B are example diagrams illustrating a cross-sectional views of an example apparatus for shielding an optical sensor assembly matching the parabolic view angle of an example sensor in accordance with various embodiments of the present disclosure;

FIGS. 5A-5F are example diagrams of an example apparatus for shielding an optical sensor assembly fan inlet in accordance with various embodiments of the present disclosure;

FIG. 6 is an example perspective view of an example apparatus for shielding an optical sensor assembly with a filter in accordance with various embodiments of the present disclosure;

FIGS. 7A and 7B are example perspective views of an example system for shielding an optical sensor assembly on an example manufacturing line in accordance with various embodiments of the present disclosure;

FIGS. 8A and 8B are example top and bottom views, respectively, of an example system for shielding an optical sensor assembly with a filter in accordance with various embodiments of the present disclosure;

FIG. 9 is an example perspective view of an example system for shielding an optical sensor assembly without a filter in accordance with various embodiments of the present disclosure;

FIGS. 10A-10E show angled and exploded views of an example system for shielding one or more sensor assemblies in accordance with various embodiments of the present disclosure; and

FIG. 11 is an example flow diagram of an example method for protecting an optical sensor assembly from debris in accordance with various embodiments of the present disclosure.

### DETAILED DESCRIPTION OF EXEMPLARY EMBODIMENTS

Various embodiments of the present disclosure now will be described more fully hereinafter with reference to the accompanying drawings, in which some, but not all various embodiments of the disclosure are shown. Indeed, this disclosure may be embodied in many different forms and should not be construed as limited to the various embodiments set forth herein; rather, these various embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers may refer to like elements throughout. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily may refer to the same embodiment).

Various embodiments of the present disclosure may be implemented as computer program products that comprise articles of manufacture. Such computer program products may include one or more software components including, for example, applications, software objects, methods, data structures, and/or the like. A software component may be coded in any of a variety of programming languages. An illustrative programming language may be a lower-level programming language such as an assembly language associated with a particular hardware architecture and/or operating system platform/system. A software component comprising assembly language instructions may require conversion into executable machine code by an assembler prior to execution by the hardware architecture and/or platform/system. Another example programming language may be a higher-level programming language that may be portable across multiple architectures. A software component comprising higher-level programming language instructions may require conversion to an intermediate representation by an interpreter or a compiler prior to execution.

As should be appreciated, various embodiments of the present disclosure may also be implemented as methods, apparatuses, systems, computing devices, computing entities, and/or the like. As such, various embodiments of the present disclosure may take the form of a data structure, apparatus, system, computing device, computing entity, and/or the like executing instructions stored on a computer-readable storage medium to perform certain steps or operations. Thus, various embodiments of the present disclosure may also take the form of an entirely hardware embodiment, an entirely computer program product embodiment, and/or an embodiment that comprises combination of computer program products and hardware performing certain steps or operations.

Various embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary various embodiments, retrieval, loading, and/or execution may be performed in parallel such that multiple instructions are retrieved, loaded, and/or executed together. Thus, such various embodiments can produce specifically-configured machines performing the steps or operations specified in the block diagrams and flowchart illustrations. Accordingly, the block diagrams and flowchart illustrations support various combinations of various embodiments for performing the specified instructions, operations, or steps.

### Overview of Exemplary Systems and Apparatuses

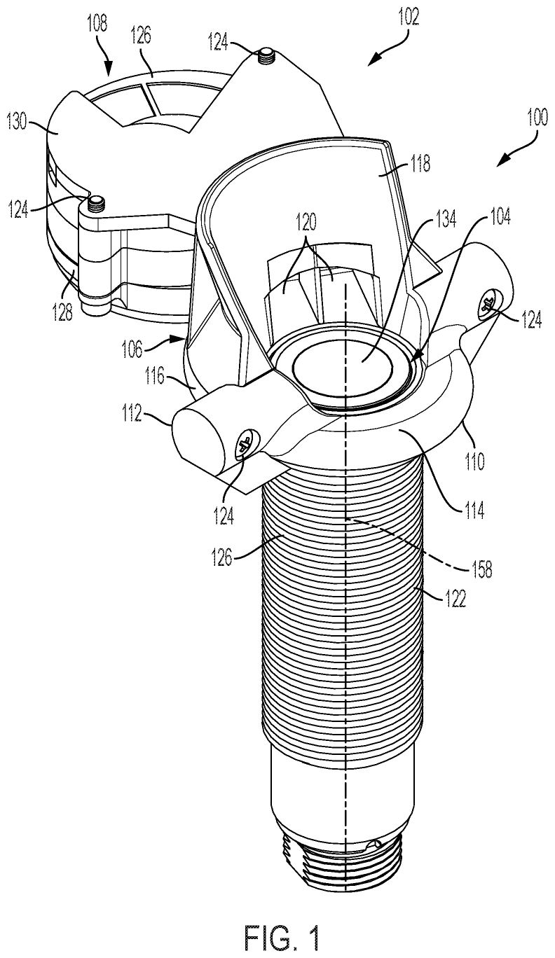

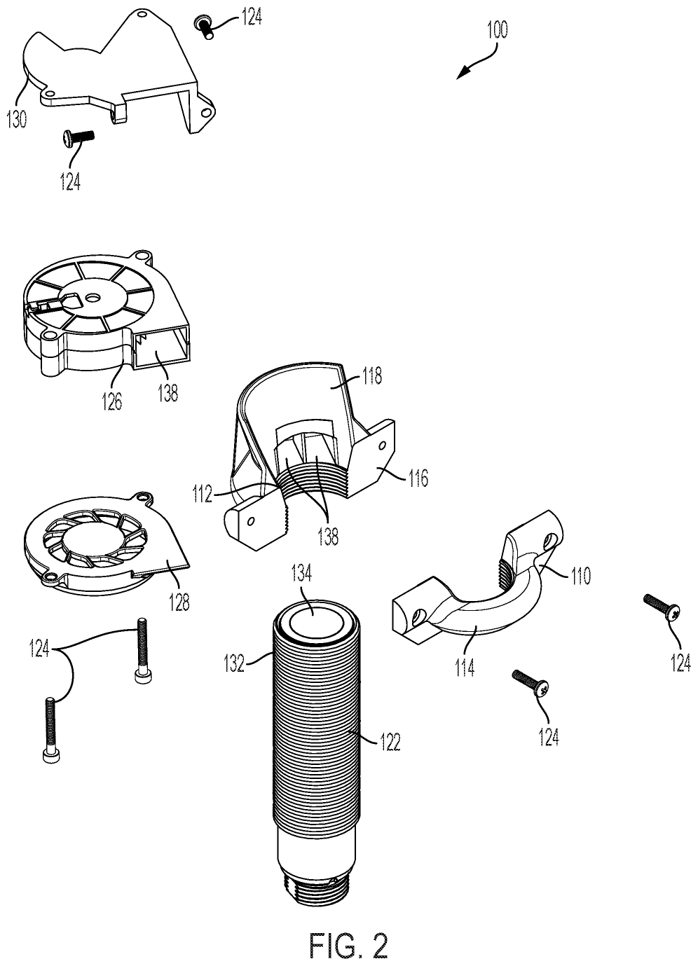

FIG. 1 is an example isometric view of an example system for shielding an optical sensor assembly 100 that can be used in accordance with various embodiments of the present disclosure. FIG. 2 is an example exploded view of an example system for shielding an optical sensor assembly 100 and its various components that can be used in accordance with various embodiments of the present disclosure.

According to various embodiments, and as shown in at least FIGS. 1 and 2, the assembly 100 may include an apparatus 102 (e.g., apparatus for shielding an optical sensor assembly) and a sensor assembly 104. In some embodiments, the apparatus 102 is configured to shield the sensor assembly 104 from debris.

According to various embodiments, and as further shown in at least FIGS. 1 and 2, the apparatus 102 may include a housing assembly 106 and a fan assembly 108. According to some embodiments, the housing assembly 106 may include a first housing component 110 and a second housing component 112. In some embodiments, the second component 112 may be configured for selective attachment to the first component 110. In some embodiments, the first component 110 may have a first annular portion 114. In certain embodiments, the second component 112 may have a second annular portion 116. In still other embodiments, the second annular portion 116 may be opposite the first annular portion 114. In certain embodiments, the housing assembly 106 may attach to the sensor assembly 104 by operatively connecting the first and second annular portions 114, 116 together and then attaching the portions 114, 116 to the shaft 122 of the sensor assembly 104 (e.g., by, in certain embodiments, threads on the first and second annular portions 114, 116 that thread onto the threads 132 of shaft 122). According to other embodiments, the second component 112 may have a curved portion 118. In certain embodiments, the curved portion 118 may extend from the second annular portion 116. In various other embodiments, the curved portion 118 may have at least one opening defining at least one airflow passage 120 that extends through the curved portion 118. In certain embodiments, this curved portion 118 may have a parabolic profile. However, it will be understood that the curved portion 118 may also have a profile of other planar curves (e.g., conic, elliptical, hyperbolic). According to some embodiments, the at least one opening defining at least one airflow passage 120 may extend through the curved portion 118, from an interior surface to an exterior surface. In some embodiments, the interior surface is the surface of the second component 112 that faces inward, toward the first component 110. According to some embodiments, the exterior surface is the surface of the second component 112 that faces outward, toward the fan assembly 108. In certain embodiments, the at least one opening defining at least one airflow passage 120 may have a decreasing cross-sectional area that extends from the exterior surface to the interior surface of the curved portion 118. In some embodiments, the first and second annular portions 114, 116 may collectively define a central opening of the housing assembly sized to receive and secure a portion of the shaft 122 of the sensor assembly 104. In some embodiments, this central opening formed by the joining of the first and second annular portions 114, 116 may define a longitudinal axis 158. In some embodiments, the first and second housing components 110, 112 may be joined by various fasteners 124 (e.g., socket head cap screws).

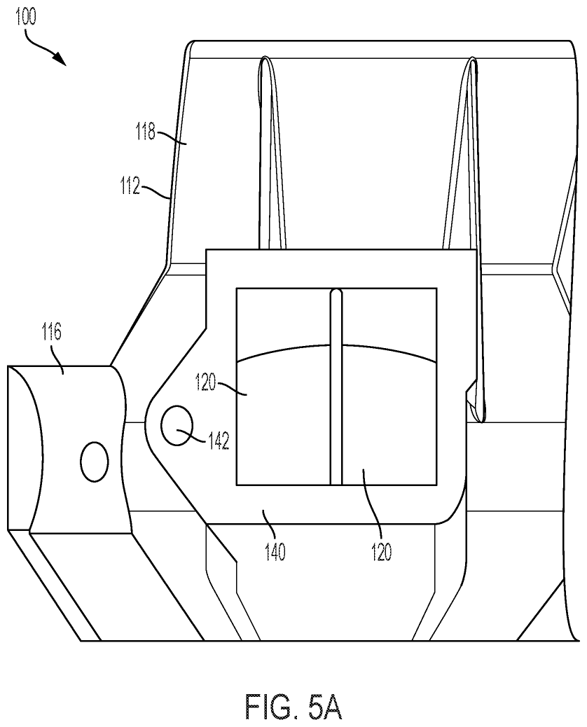

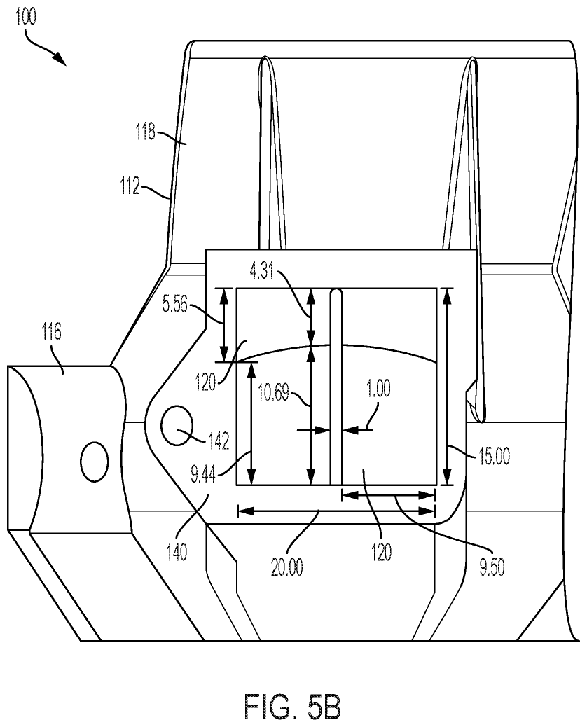

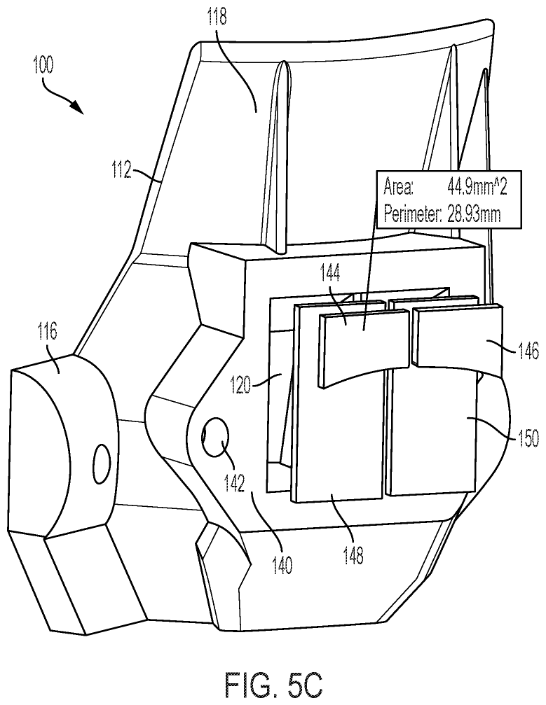

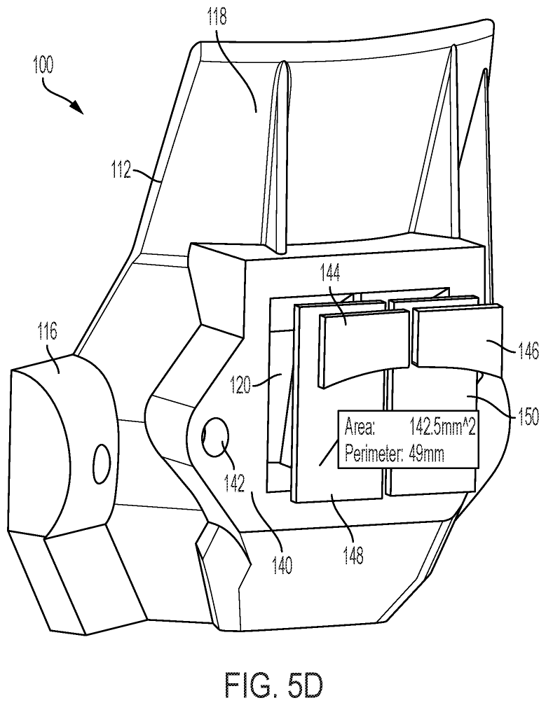

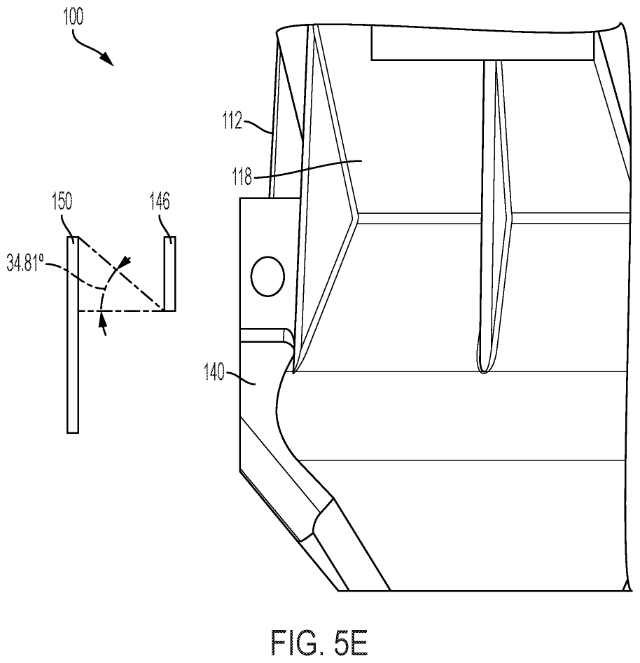

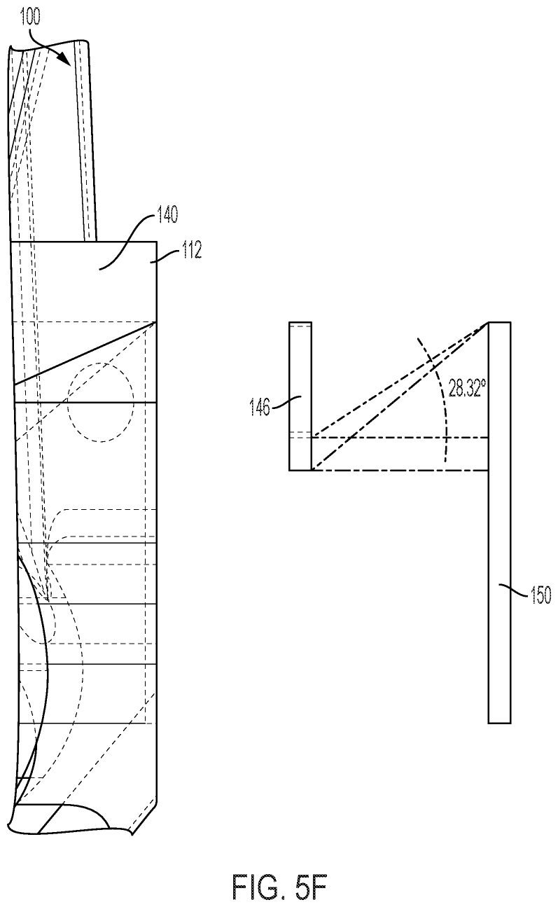

According to various embodiments, the apparatus 102 may further include a fan assembly 108. In some embodiments, the fan assembly 108 may include a fan housed in a fan housing 126, which in certain embodiments, may include a fan shield 128, and a fan shield 130. In some embodiments, the fan housing 126 may have the “snail shell” design shown in at least FIG. 2. However, it will be understood that the fan housing 126 may take on any shape that is compatible with any fan that is compatible with the assembly 100. In some embodiments, the fan base 128 and the fan shield 130 may be selectively attachable to a respective top and bottom (i.e., any opposing surfaces) of the fan housing 126. In other embodiments, the fan base and fan base 128, 130 may be selectively attached to opposed sides of the fan housing 126. In some embodiments, the fan assembly 108 may include a filter 154 located within the fan base 128. According to some embodiments, the fan assembly 108 may have its components joined by various fasteners 124 (e.g., socket head cap screws, industrial screws, or the like). According to some embodiments, the fan assembly 108 is connected to the second housing component 112. In some embodiments, the fan housing 126 may be mounted adjacent to an exterior surface of the curved portion 118 of the second component 112; and, in certain embodiments, this positioning of the fan 126 may allow airflow from the at least one opening defining at least one airflow passage 120 of the second component's curved portion 118 to receive airflow from the fan 126, and that airflow, in certain embodiments, may be directed through the at least one opening defining at least one airflow passage 120 of the curved portion 118. This is explained in further detail at a later point in the disclosure, in reference at least FIGS. 5A-5F.

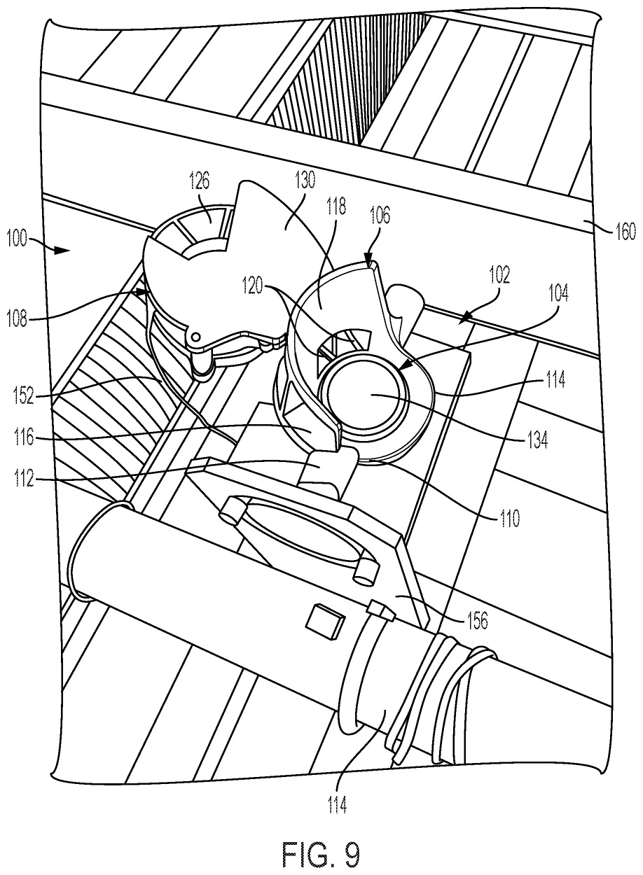

According to some embodiments, the fan in the fan housing 126 may be a 24V fan. In some embodiments, the fan in the fan housing 126 may be a 5015 blower fan. In other various embodiments, and as shown in at least FIG. 9, the fan in the fan housing 126 may be a mechatronics 5015 fan. In these and other embodiment the fan may be any of a variety of blower fans available commercially. In some embodiments, and as shown in at least FIG. 2, the fan in the fan housing 126 may have at least one airflow opening 138.

According to some embodiments, and as further shown in at least FIGS. 1 and 2, the fan shield 130 may be in the shape of an eyelid. However, it will be understood that the fan shield 130 may be shaped in any number of suitable designs for deflecting debris away from the sensor assembly 104.

According to some embodiments, the fan assembly 108 may be angled in relation to the shaft 122 of the sensor assembly 104. According to some embodiments, the fan assembly 108 may be angled to blow air such that debris is deflected away from the photo lens 134 of the sensor assembly 104. According to some embodiments, the fan assembly 108 may be angled from a range of 20-60 degrees. In other various embodiments, the fan assembly 108 may be angled at 45 degrees. It will be understood that the fan assembly 108 may be positioned at any number of appropriate angles for effectively deflecting debris away from the sensor assembly 104. According to some embodiments, the fan assembly 108 may be angled slightly in the direction of the photo lens 134 of the sensor assembly 104. In other embodiments the fan assembly may be angled relative to the lens 134, but differently from an angle of the passages of airflow, as described elsewhere herein. According to some embodiments, the fan in the fan housing 126 may blow air at a rate of 2,500 feet per minute. However, it will be understood that, according to other various embodiments, the fan in the fan housing 126 may blow air at any suitable rate to effectively direct debris away from the photo lens 134 of the sensor assembly 104.

According to some embodiments, and as shown in at least FIG. 2, the assembly 100 may further include a fan base 128. In some embodiments, the fan base 128 may filter debris particles blown by the fan 108. It will be understood that, according to some embodiments, the assembly 100 will function just as well, if not better, without a fan base 128 than with a fan base 128. It will further be understood that the use of a fan base 128 may vary according to the application of the sensor assembly 104 and the assembly 100 more generally. For example, in some embodiments, depending on the size and volume of the debris, a fan base 128 may be more or less effective in keeping the sensor clear of debris while also ensuring the assembly 100 functions effectively.

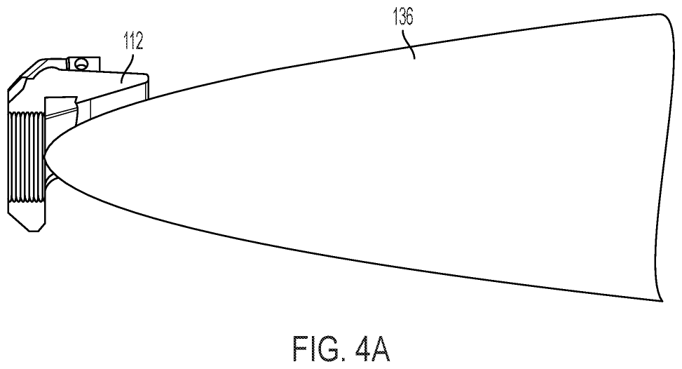

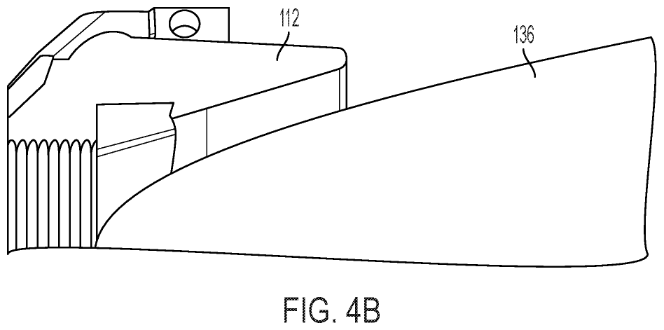

According to some embodiments, and as further shown in at least FIGS. 1 and 2, the assembly 100 further includes a sensor assembly 104, to which the apparatus for shielding an optical sensor assembly 102 may be coupled, for example, by means of fasteners 124. According to some embodiments, first and second housing components 110, 112 may be attached to the sensor assembly 104 (e.g., by threading the apparatus 102 onto the threads 132 of the sensor assembly 104). In some embodiments, the sensor assembly 104 may have a photo lens 134. In some embodiments, the sensor assembly may have a shaft 122. In certain embodiments, and as shown in FIG. 1, the shaft 122 may be aligned with the longitudinal axis 158. In some embodiments, the shaft 122 may be rigid. In some embodiments, the photo lens 134 may be mounted on the shaft 122 of the sensor 104. In some embodiments, the lens 134 may define a plane that is aligned with a surface of the lens 134 and defines a view profile 136 away from the lens 134 of the sensor assembly 104 (see, e.g., FIGS. 4A-4B).

According to some embodiments, the sensor assembly 104 may be a range opposed barrel sensor. In some embodiments, the sensor assembly 104 may be a Banner SM30 series sensor. According to some embodiments, and as discussed in greater detail with respect to at least FIGS. 4A and 4B, the sensor assembly 104 may have a parabolic view profile 136. According to some embodiments, and also as discussed in greater detail with respect to at least FIGS. 4A and 4B, the first and second housing components 110, 112 may be configured to align with this parabolic view profile 136 of the sensor assembly 104. Additionally, according to some embodiments, the curved portion 118 of the second component 112 may be shaped to conform with the shape of the view profile 136, such that the view profile is not obstructed in any way by the housing assembly 106.

According to some embodiments, the central opening formed by the first and second annular portions of the housing assembly 114, 116 may define a plane that runs perpendicular to the longitudinal axis 158 of the housing assembly 106, the longitudinal axis 158 also being defined by the first and second annular portions of the housing assembly 114, 116. In these and other embodiments, although not labeled in the figures, the plane may be understood as generally a plane in which the eye of the lens of the sensor assembly 104 lies. Separate from the sensor assembly, the plane may also be understood as lying adjacent a portion of the annular portions of the housing assembly that is axially aligned with the lens. In some embodiments, a longitudinal axis of the fan 126 defined by the at least one airflow opening 138 may be offset at an acute angle relative to this plane defined by the first and second annular portions of the housing assembly 114, 116. In certain embodiments, this angle may range from 18 to 35 degrees. In still other embodiments, this acute angle may be 28 degrees.

According to some embodiments, the fan assembly 108 may be offset at an acute angle relative to the longitudinal axis 158 that is defined by the first and second annular portions 114, 116 of the housing assembly 106. For example, in certain embodiments, the fan assembly 108 may be offset by a range of 55 to 72 degrees. In other embodiments, the fan assembly 108 may be offset at an acute angle relative to the plane perpendicular to the plane defined by the lens 134 that is aligned with a surface of the lens 134 and defines a view profile 136 away from the lens 134 of the sensor assembly 104. In certain embodiments, this acute angle may be in a range of 18 to 35 degrees.

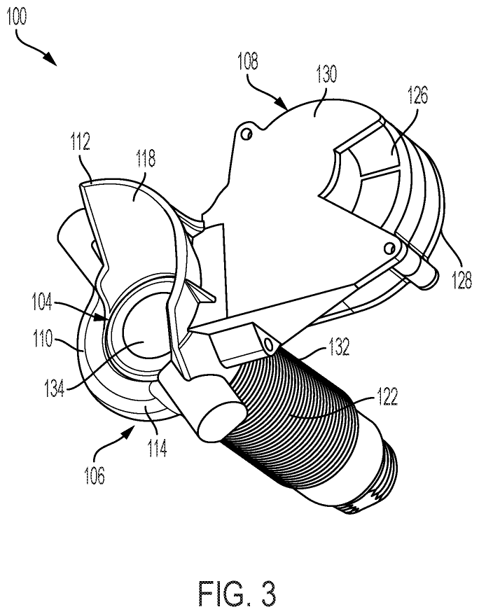

FIG. 3 is an example perspective view of an example system for shielding an optical sensor assembly in accordance with various embodiments of the present disclosure. As shown in FIG. 3 and as previously referenced in the specification, according to some embodiments, the sensor assembly 104 of the assembly 100 may include a photo lens 134. According to some embodiments, a lens may be, for example, any optical device that focuses or disperses light.

### Exemplary Apparatus, Sensor, and Fan Designs

FIGS. 4A and 4B are example diagrams illustrating respective cross-sectional views of an apparatus for shielding an optical sensor assembly matching the parabolic view angle of an example sensor in accordance with various embodiments of the present disclosure.

According to some embodiments, the photo lens 134 may have a view angle 136 that is parabolic. It will be understood that, in some embodiments, when the view angle 136 is parabolic, then the curved portion 118 of the second component 112, is also parabolic. In other embodiments, when the view angle 136 is conic, the curved portion 118 of the second component 112 may also be conic. In still further embodiments, the curved portion 118 of the second component 112 may generally be shaped as the planar curve shape of the view angle 136.

FIGS. 5A-5F are example diagrams of an example apparatus 102 for shielding an optical sensor assembly fan inlet in accordance with various embodiments of the present disclosure. In some embodiments, the longitudinal axis of the at least one opening 120 may be offset at an acute angle relative to the longitudinal axis 158 of the housing assembly 106. This acute angle may range, in some embodiments, from 55 to 72 degrees (i.e., 18-35 degrees relative to the lens plane described elsewhere herein). The acute angle may, in other embodiments, have a range of 45 to 90 degrees. In other embodiments, this angle may be approximately 62 degrees, or approximately 61 degrees, or approximately 63 degrees. It will be understood that the acute angle may be at whatever degree is appropriate and effective to obtain the desired functioning of the assembly 100.

According to some embodiments, and as shown in at least FIGS. 5A-5D, the second component 112 may include a mounting bracket 140. In certain embodiments, the mounting bracket 140 may have a mounting hole 142. According to some embodiments, the second component 112 may be operatively mounted to the fan assembly 108 at the mounting hole 142. In additional embodiments, a fastener 124 may be used in the mounting hole 142 to secure the mounting bracket 140 and the second component 112 to the fan assembly 108.

According to some embodiments, and as shown in at least FIGS. 5C-5F, the “angle of attack” for which air blows through the opening 120 may be varied by varying the size of the opening or openings 120, and/or by changing the cross-sectional area of the opening 120 as the opening 120 moves from the exterior of the second housing component 112 to the interior of the second housing component 112. Although measurements are provided in FIGS. 5C and 5D, it will be understood that these are exemplary only, and that the measurement of the areas 144, 146, 148, and 150 are not constrained to the displayed measurements. It will be further understood that, in some embodiments, the size of the area may vary between the more than openings 120. For example, in some embodiments, the area of the left opening may be larger than the area of the right opening 120, and vice-versa. For example, in some embodiments, the area may decrease from approximately 142 square millimeters to approximately 50 square millimeters. However, it will be understood that this is exemplary and other compatible areas may be used in some embodiments.

As shown in FIGS. 5E and 5F, which are side views of the figures shown in FIGS. 5C-5D, the angle of attack may be derived from the difference in sizes of the areas 144, 146, 148, and 150. Measurements are provided in FIGS. 5E and 5F, but it will be understood that these are exemplary measurements, and that the angle of attack is not limited to the angle shown in FIGS. 5E and 5F.

### Example System for Shielding an Optical Sensor Assembly Use Cases

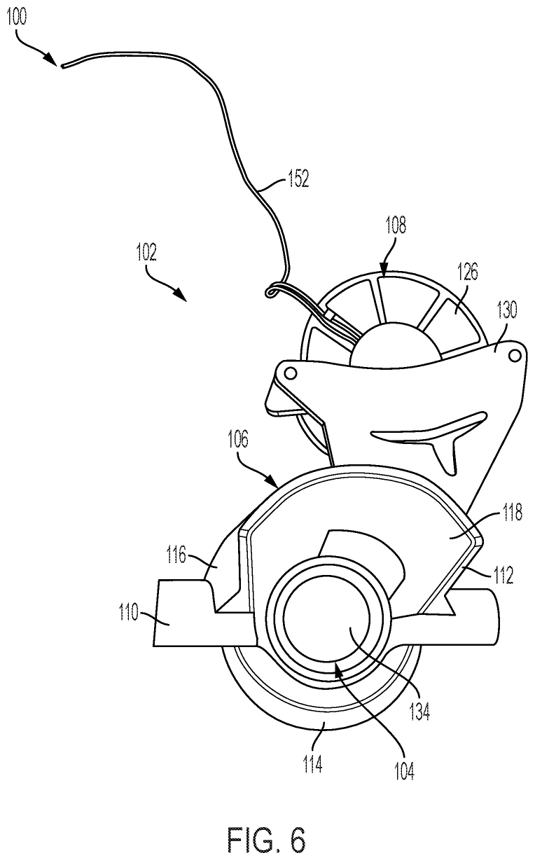

FIG. 6 is an example perspective view of an example apparatus for shielding an optical sensor assembly 102 with a filter in accordance with various embodiments of the present disclosure. As shown in FIG. 6, and according to some embodiments, the assembly 100 may include wiring 152. According to some embodiments, the wiring 152 may be connected to a power source to power the sensor assembly 104 and/or the fan in the fan housing 126. In some embodiments, the fan in the fan housing 126 and the sensor assembly 104 may share a power source (e.g., apparatus 102 is attached to an emitter device of a sensor assembly 104). However, in other embodiments, the fan in the fan housing 126 and the sensor assembly 104 may have separate power sources.

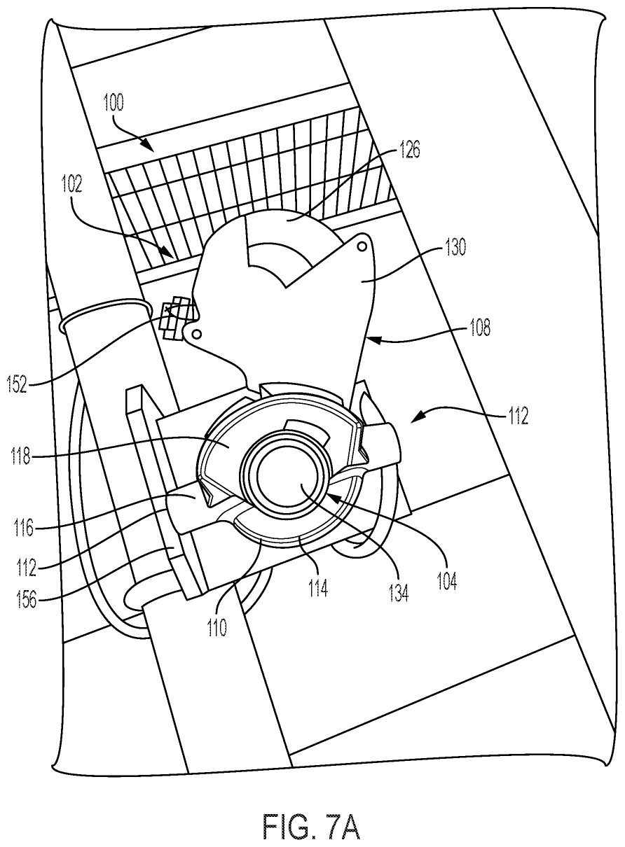

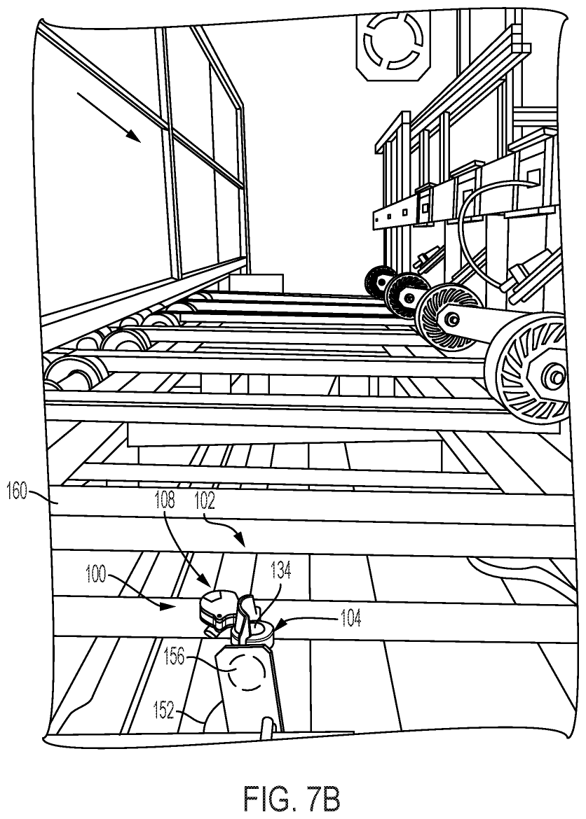

FIGS. 7A and 7B are example perspective views of an example system for shielding an optical sensor assembly 100 on an example manufacturing line in accordance with various embodiments of the present disclosure. As shown in at least FIGS. 7A and 7B, in some embodiments, the assembly 100 may include a bracket 156 that may connect to the sensor assembly 104 and/or the apparatus 102 in the assembly line or manufactory. As shown in at least FIG. 7B, the assembly 100 may be placed in a manufacturing production line. In some embodiments, the sensor assembly 104 may be configured to sense when a product (e.g., board 160) is “on-line.” In some embodiments, the sensor assembly 104 may be configured to report this information back to a central controller or logic device.

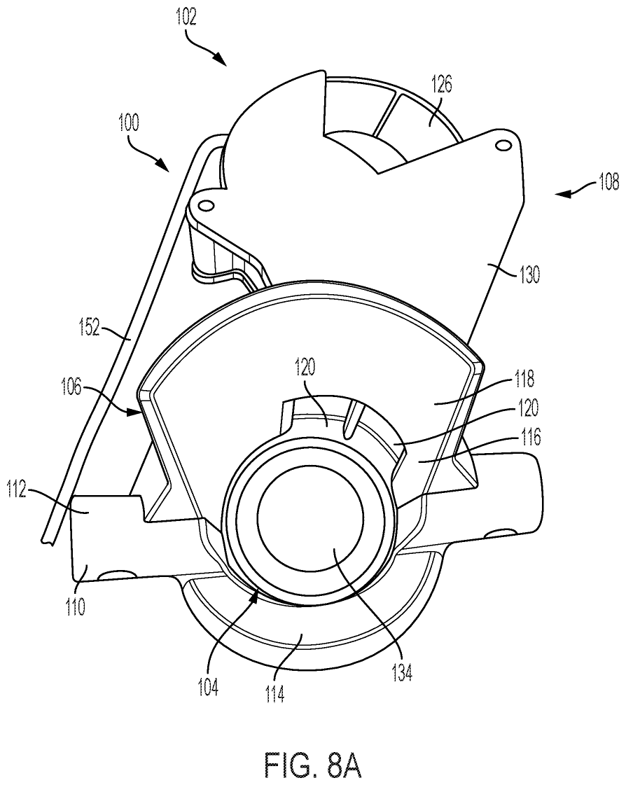

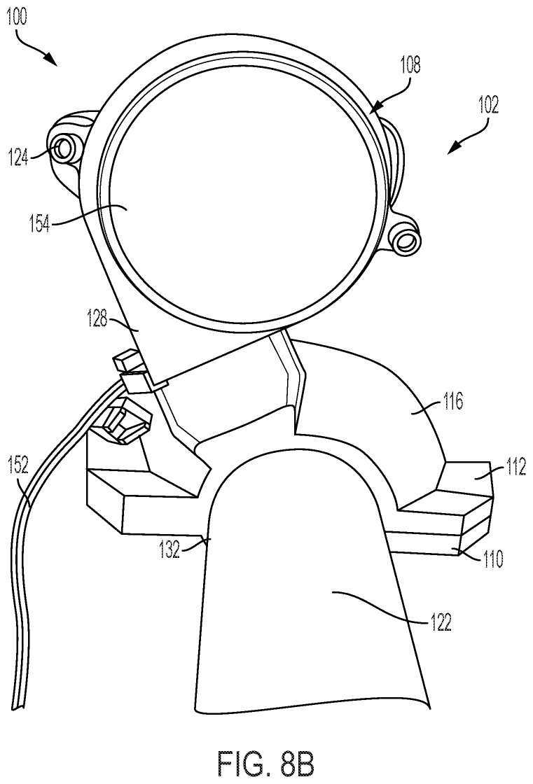

FIGS. 8A and 8B are example top and bottom views, respectively, of an example system for shielding an optical sensor assembly 100 with a filter 154 in accordance with various embodiments of the present disclosure. As shown in FIG. 8B, the filter 154 may be fitted in the base 128 of the fan assembly 108. It should be understood that relative ‘top’ and ‘bottom’ terminology relates only to one exemplary mounting of the system for shielding an optical sensor assembly 100; in certain embodiments, as may be advantageous, the system may be mounted relative to the optical sensor otherwise (e.g., with the bottom becoming the top, so as to drive airflow downwards). In these and other embodiments, it should be understood that positioning of the sensor may also be other than vertical, as illustrated.

FIG. 9 is an example perspective view of an example system for shielding an optical sensor assembly without a filter in accordance with various embodiments of the present disclosure. In some embodiments, a filter 154 may be used to protect the assembly 100 from debris. However, it will be understood that the assembly 100 may also function without such a filter 154, as shown in at least FIG. 9.

### Example Airshield Ionizer System

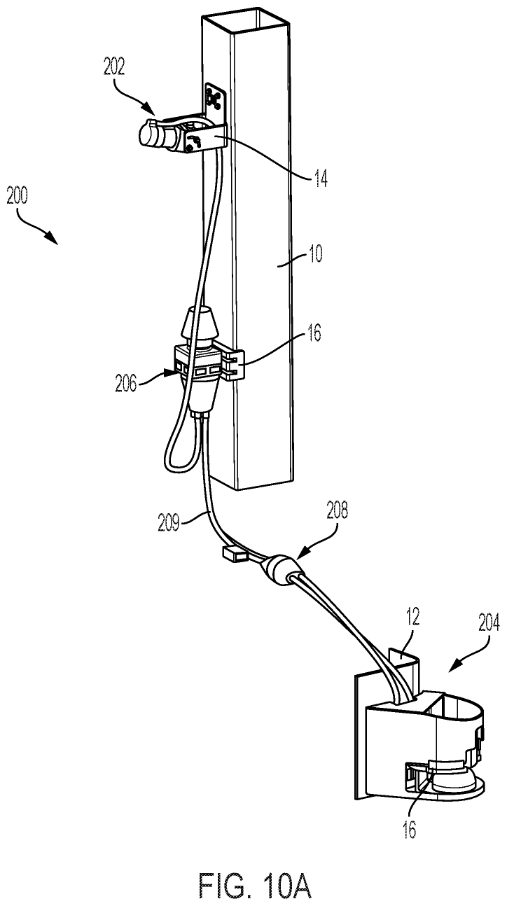

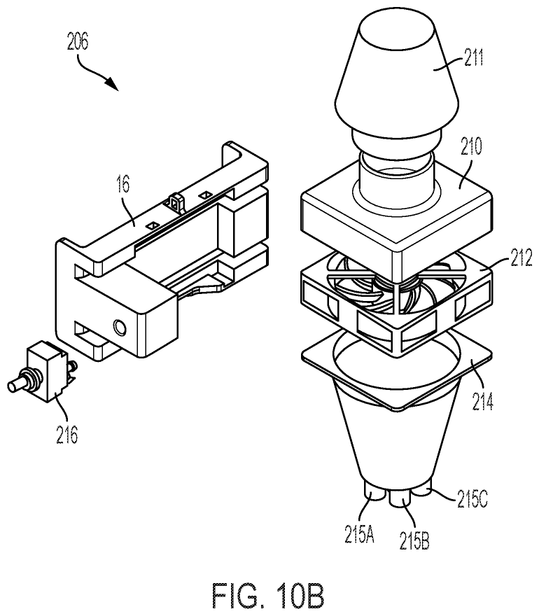

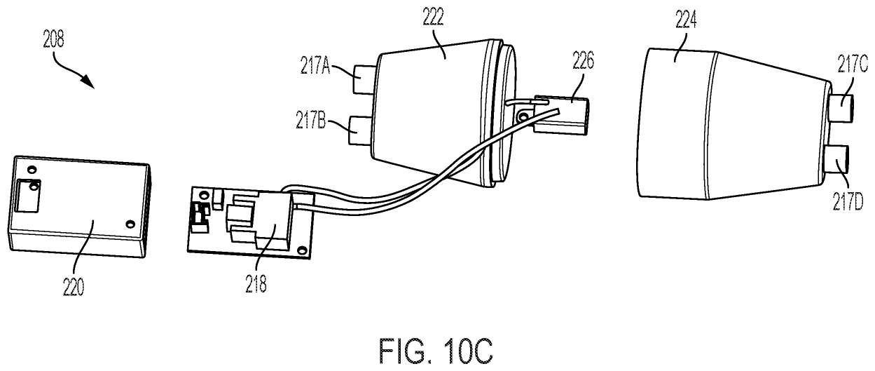

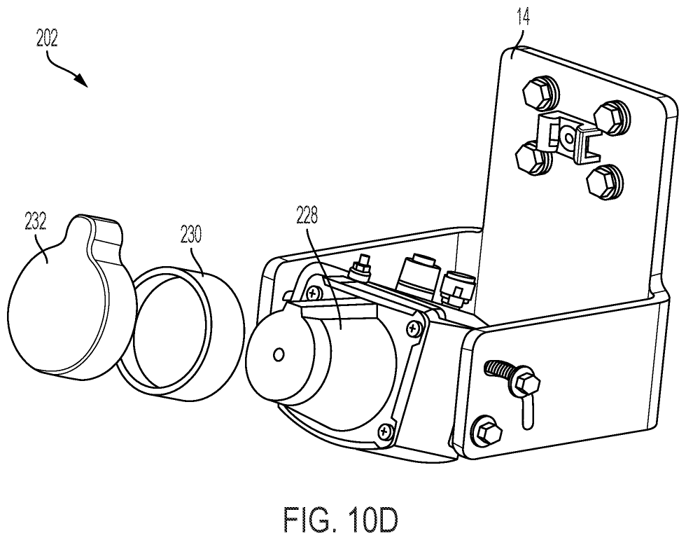

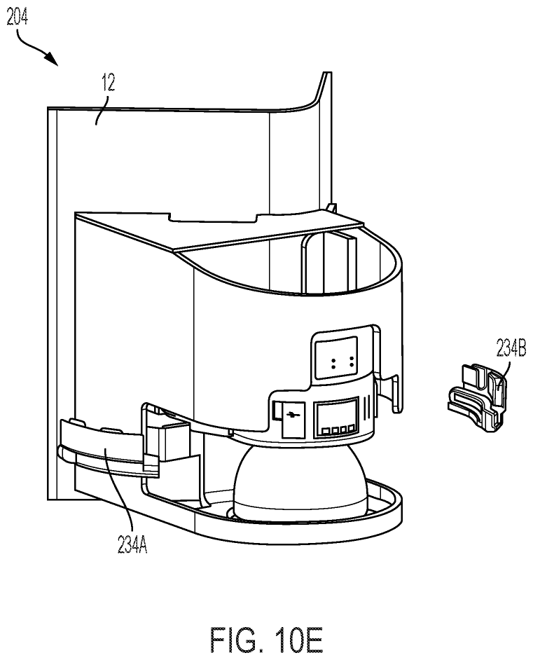

FIGS. 10A-10E show angled and exploded views of an example filtration and ionization system 200 (“system 200”), according to various embodiments. In some embodiments, the system 200 may be configured to utilize pressurized, filtered, and/or ionized air to shield one or more of a first scanner assembly 202 and a second scanner assembly 204. In some embodiments, static charge may build up on one or more components of the first or second scanner assemblies 202, 204, and the use of ionized air may reduce and/or prevent this buildup, along with the filtered air to prevent particulate buildup as previously described with respect to assembly 100. According to various embodiments, the components of the filtration and ionization system 200 may be used with the optical sensor assembly 100.

In some embodiments, the filtration and ionization system 200 may include a fan assembly 206 configured to provide air throughout the system such that the air may be blown over or across a surface of the first and/or second scanner assemblies 202, 204 to keep the first and/or second scanner assemblies 202, 204 clear of particular matter. In some embodiments, the filtration and ionization system 200 may include one or more ionizer assemblies 208. One ionizer assembly 208 is shown in FIG. 10A as be connecting to both the first and second scanner assemblies 202, 204, but it will be understood that the system 200 may include multiple ionizer assemblies. In some embodiments, one ionizer assembly 208 may be connected to and provide ionizer air to the first and/or second scanner assembly 202, 204.

In some embodiments, the one or more assemblies of the filtration and ionization system 200 may be fixedly attached to one or more fixed structures 10, which may be a pillar, beam, and/or other fixed structure in the environment where the filtration and ionization system 200 is to be disposed and/or utilized. In some embodiments, the one or more assemblies of the filtration and ionization system 200 may be fixedly attached to one or more mobile or dynamic structures 12, such as a mobile platform and/or the like in the environment where the filtration and ionization system 200 is to be disposed and/or utilized. In some embodiments, the one or more assemblies may be fixed to the structures 10 via one or more brackets 14,16. In some embodiments, the one or more assemblies may be integrated into the structures 10, 12. It will be understood that there are various methods and means by which the assemblies may be fixedly attached or operably engaged to the one or more structures 10, 12.

In some embodiments, the one or more assemblies may be connected via tubing 209. In some embodiments, the tubing 209 may be split and/or routed in various ways to connect the one or more assemblies. For example, as shown in FIG. 10A, the tubing 209 may connect the fan assembly 206 to both the first scanner assembly 202 and the second scanner assembly 204. It will be understood that the tubing 209 may be routed in a variety of configurations to link the one or more assemblies in various orientations.

Referring now to FIG. 10B (but also to FIG. 10A) an the example fan assembly 206 may be configured to blow air (through the tubing 209) to prevent dust and other particulate matter collecting on one or more lenses of the first or second scanner assemblies 202, 204.

In some embodiments, the fan assembly 206 may include a filter 211. In some embodiments, the filter 211 may be a cone-shaped filter. It will be understood that various shapes and designs may be used for the filter 211. In some embodiments, the filter 211 may filter air as air enters the fan assembly 206, removing particulate matter and other non-desirable components from the air.

In some embodiments, the fan assembly 206 may include an inlet manifold 210. In some embodiments, air may pass into the inlet manifold 210 after passing through the filter 211. In some embodiments, the inlet manifold 210 may be square or rectangular in shape and include an elongated, cylindrical component that may be slotted into and operably engage with the filter 211, as shown in at least FIGS. 10A and 10B.

In some embodiments, the fan assembly 206 may include a fan 212. In some embodiments, the fan 212 may be a square or rectangular shaped fan and/or a 24 V (DC) axial fan. In some embodiments, the fan 212 may be aligned with the inlet manifold 210. In some embodiments, the fan 212 may be configured to draw air into the fan assembly 206 and distribute it throughout the tubing 209.

In some embodiments, the fan assembly 206 may include a nozzle box 214 disposed beneath the fan 212. In some embodiments, the nozzle box 214 may be cone-shaped and include one or more outlet points 215A, 215B, and 215C to which the tubing 209 may be connected to distribute air throughout the system 200.

In some embodiments, the fan assembly 206 may include a switch 216. In some embodiments, the switch 216 may be a two-position switch configured to activate the fan assembly 206 in a first position and deactivate the fan assembly 206 in a second position. It will be understood that various types of switches and actuators may be used to activate and deactivate the fan assembly 206, as desired.

Referring now to FIG. 10C, an angled, exploded view of the example ionizer assembly 208 is shown, according to some embodiments. In some embodiments, the ionizer assembly 208 may be used to ionize air as it passes through the system 200. In some embodiments, the air may be ionized by the ionizer assembly 208 to prevent adherence to one or more components of the scanner assemblies 202, 204. In some embodiments, the ionizer assembly 208 may include an ionizer unit 218 configured to introduce a static charge to the air and thereby ionize the air as it passes through the ionizer assembly 208. In some embodiments, the ionizer unit 218 may be housed within a cover 220, which may be substantially rectangular in shape. In some embodiments, the ionizer unit 218 and/or the cover 220 may be disposed within the first and/or second housing components 222, 224. In some embodiments the housing components 222, 224 may be substantially cone shaped and configured to be snap-fit together. In some embodiments, each of the housing components 222, 224 may include one or more outlet points 217A, 217B, 217C, and 217D configured to connect to the tubing 209. In some embodiments, the ionizer unit 218 and/or the cover 220 may be attached to a mount point 226 within the housing components 222, 224.

Referring now to FIG. 10D, an exploded view of the example first scanner assembly 202 is shown, according to some embodiments. In some embodiments, the first scanner assembly 202 may be a look-down camera assembly. In some embodiments, static charge may build up one or more components of the first scanner assembly 202 (e.g. on the lens), and the use of ionized air may reduce the buildup and/or negative effects of the buildup (e.g., greater particulate adhesion to the components). In some embodiments, the first scanner assembly 202 may include an imaging device 228, such as a camera or sensor.

In some embodiments, the first scanner assembly 202 may include a nozzle 230 and a nozzle cap 232. In some embodiments, the nozzle 230 and/or nozzle cap 232 may be placed over the imaging device 228 to protect it from dust and other particulate matter when the first scanner assembly 202 is not in use.

Referring now to FIG. 10E, an exploded view of the example second scanner assembly 204 is shown, according to some embodiments. In some embodiments, the second scanner assembly 204 may be a mobile scanner configured to move with one or more pieces of machinery. In some embodiments, mobility may increase the likelihood and/or degree to which static charge builds up on one or components of the second scanner assembly 204. In some embodiments, the second scanner assembly 204 may include one or more air nozzles 234A, 234B. In some embodiments, the one or more air nozzles 234A, 234B may be positioned in parallel on either side of the second scanner assembly 204 and configured to disperse air from multiple directions across the second scanner assembly 204. In some embodiments, the one or more air nozzles 234A, 234B may be connected to the tubing 209 and configured to disperse filtered and ionized air across one or more imaging components of the second scanner assembly 204.

### Example Airshield Methods of Use

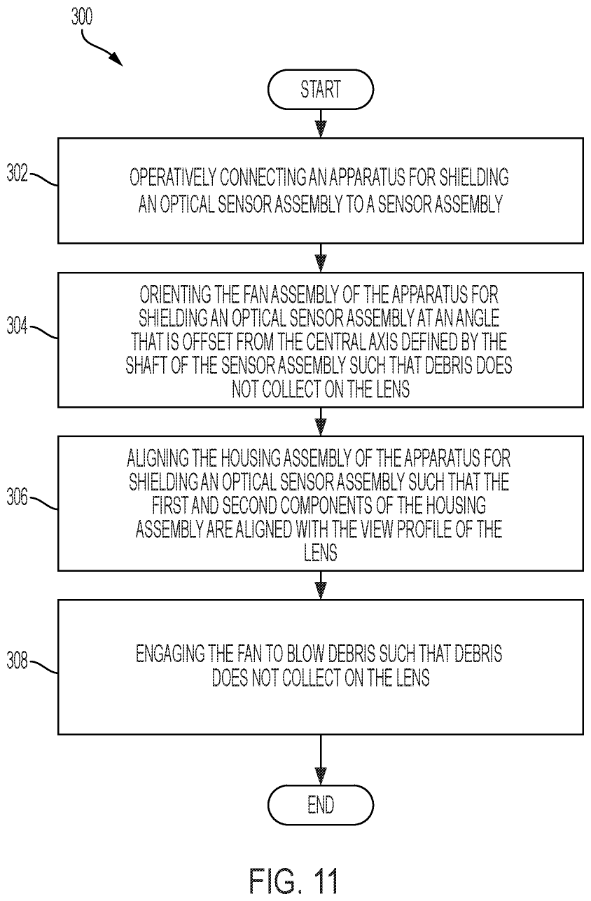

FIG. 11 is an example flow diagram of an example method 300 for protecting a lens from debris in accordance with various embodiments of the present disclosure. The method shown in the flow chart in FIG. 10 is discussed in reference to the assembly 100 shown in, for example, FIG. 1. However, it will be understood that the method 300 may be used in reference to other systems (e.g., the filtration and ionization system 300) that may perform the steps.

According to some embodiments, as shown in FIG. 11, the method 300 may include step 302 of operatively connecting an apparatus 102 for shielding an optical sensor assembly to a sensor assembly 104. In some embodiments, the method 200 may also include step 304 of orienting the fan assembly 108 of the apparatus 102 for shielding an optical sensor assembly at an angle that is offset from the central axis defined by the shaft of the sensor assembly (which, in some embodiments, may be the longitudinal axis 158) such that debris does not collect on the lens 134. In other embodiments, the method 200 may additionally include step 306 of aligning the housing assembly 106 of the apparatus 102 for shielding an optical sensor assembly 104 such that the first and second components 110, 112 of the housing assembly 106 are aligned with the view profile 136 of the lens 134. In still further embodiments, the method 200 may include step 308 of engaging the fan within the fan housing 126 to blow debris such that debris does not collect on the lens 134.

### Conclusion

Many modifications and other various embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific various embodiments disclosed and that modifications and other various embodiments are intended to be included within the scope of the appended claims. Although specific terms are employed herein, they are used in a generic and descriptive sense only and not for purposes of limitation.

1. An apparatus for shielding an adjacent lens, the apparatus comprising:
a housing assembly comprising a first component and a second component configured for selective attachment to the first component, the first component having a first annular portion and the second component having a second annular portion opposite the first annular portion, the first and second annular portions collectively defining a central opening of the housing assembly, the central opening defining a longitudinal axis of the housing assembly; and
a fan assembly comprising a fan having an airflow opening and a fan housing,
wherein:
the second component has a curved portion extending from the second annular portion and along the longitudinal axis,
the curved portion has an opening formed therethrough, the opening defining at least one airflow passage extending from an exterior surface of the curved portion to an interior surface of the curved portion, and
the fan is mounted adjacent the exterior surface of the curved portion, such that airflow from the airflow opening of the fan is directed through the at least one airflow passage of the curved portion.

2. The apparatus of claim 1, wherein the interior surface of the curved portion has a parabolic profile.

3. The apparatus of claim 2, wherein the parabolic profile of the curved portion matches a parabolic viewing angle of the adjacent lens.

4. The apparatus of claim 1, wherein the at least one airflow passage contains two distinct sub-passages, wherein each of the two distinct sub-passages has a decreasing area cross-section extending from the exterior surface to the interior surface of the curved portion.

5. (canceled)

6. The apparatus of claim 4, wherein the decreasing area cross-section decreases from an area of approximately 142 square millimeters to an area of approximately 50 square millimeters.

7. The apparatus of claim 1, wherein the at least one airflow passage has a decreasing area cross-section extending from the exterior surface to the interior surface of the curved portion.

8. The apparatus of claim 1, wherein a longitudinal axis of the at least one airflow passage is offset at an acute angle relative to the longitudinal axis of the housing assembly, wherein the acute angle is in a range of 55 to 72 degrees.

9. The apparatus of claim 8, wherein the acute angle is in a range of 55 to 72 degrees.

10. The apparatus of claim 8, wherein the acute angle is approximately 62 degrees.

11. The apparatus of claim 1, wherein the central opening of the housing assembly defines a plane perpendicular to the longitudinal axis of the housing assembly.

12. The apparatus of claim 11, wherein a longitudinal axis of the at least one airflow passage is offset at an acute angle relative to the plane defined by the central opening.

13. The apparatus of claim 12, wherein the acute angle is in a range of 18 to 35 degrees.

14. (canceled)

15. The apparatus of claim 1, wherein the fan assembly is offset at an acute angle relative to the longitudinal axis of the housing assembly, wherein the acute angle is in a range of 55 to 72 degrees.

16. (canceled)

17. The apparatus of claim 1, wherein the fan assembly is offset at an acute angle relative to a plane perpendicular to the longitudinal axis of the housing assembly, the plane being defined by the central opening of the housing assembly, wherein the acute angle is in a range of 18 to 35 degrees.

18. (canceled)

19. The apparatus of claim 1, wherein the fan assembly further comprises at least one of a base portion and a shield portion, the base and shield portions being selectively attachable to opposing sides of the fan housing, wherein the base portion has an open recess sized to receive and retain a fan filter therein.

20. (canceled)

21. The apparatus of claim 1, wherein the first and second annular portions contain threads configured to retain the first and second annular portions relative to a portion of the adjacent lens.

22. A shielded lens assembly comprising:
a sensor comprising a shaft having a lens mounted at one end thereof, the lens defining a plane aligned with a surface of the lens and having a defined view profile;
a housing assembly comprising a first component and a second component configured for selective attachment to the first component, the first component having a first annular portion and the second component having a second annular portion opposite the first annular portion, the first and second annular portions collectively defining a central opening of the housing assembly sized to receive and secure a portion of the shaft; and
a fan assembly comprising a fan having an airflow opening and a fan housing,
wherein:
the second component has a curved portion extending from the second annular portion and away from the lens,
the curved portion has an opening formed therethrough, the opening defining at least one airflow passage extending from an exterior surface of the curved portion to an interior surface of the curved portion, and
the fan is mounted adjacent the exterior surface of the curved portion, such that airflow from the airflow opening of the fan is directed through the at least one airflow passage of the curved portion.

23. (canceled)

24. (canceled)

25. The shielded lens assembly of claim 22, wherein the lens of the sensor has a conical view angle and the interior surface of the curved portion is a conical surface that matches the conical view angle of the lens.

26. (canceled)

27. (canceled)

28. (canceled)

29. (canceled)

30. The shielded lens assembly of claim 22, further comprising one or more ionizer units configured to ionize air passing through the at least one airflow passage.

31. A method for protecting a lens from debris, the method comprising:
operatively connecting an apparatus for shielding an optical sensor assembly to a sensor assembly,
wherein the optical sensor assembly comprises a shaft having a the lens mounted at one end thereof, the lens defining a plane aligned with a surface of the lens and having a defined view profile,
wherein the apparatus comprises:
a housing assembly comprising a first component and a second component configured for selective attachment to the first component, the first component having a first annular portion and the second component having a second annular portion opposite the first annular portion, the first and second annular portions collectively defining a central opening of the housing assembly sized to receive and secure a portion of the shaft, the central opening defining a longitudinal axis of the housing assembly; and
a fan assembly comprising a fan having an airflow opening and a fan housing, wherein:
the second component has a curved portion extending from the second annular portion and away from the lens,
the curved portion has an opening formed therethrough, the opening defining at least one airflow passage extending from an exterior surface of the curved portion to an interior surface of the curved portion, and
the fan is mounted adjacent the exterior surface of the curved portion, such that airflow from the airflow opening of the fan is directed through the at least one airflow passage of the curved portion;
orienting the fan assembly of the apparatus for shielding the optical sensor assembly at an angle that is offset from a central axis defined by the shaft of the sensor assembly such that debris does not collect on the lens;
aligning the housing assembly of the apparatus for shielding the optical sensor assembly such that the first and second components of the housing assembly are aligned with the defined view profile of the lens; and
engaging the fan to blow debris such that debris does not collect on the lens.
